(19) United States
(12) Patent Application Publication
(10) Pub. No.: US 2020/0047328 A1
(43) Pub. Date: Feb. 13, 2020

(54) Streetlight capable of reducing air pollution of road

(71) Applicant: Biyun Lou, Xiamen City (CN)

(72) Inventor: Biyun Lou, Xiamen City (CN)

(21) Appl. No.: 16/660,778

(22) Filed: Oct. 22, 2019

(30) Foreign Application Priority Data
Jun. 29, 2019 (CN) 2019105789986

(51) Int. Cl. B25H 7/04; F21S 8/08

(52) U.S. Cl. CPC B25H 7/045; F21W 2131/103; F21S 8/086

(57) ABSTRACT

This invention discloses a streetlight capable of reducing air pollution of road, including a marking box (10); a marking cavity (11) disposed in the marking box (10), wherein the marking cavity (11) is provided with a laser marker (12), a rotation mechanism (90), power mechanisms (92) and a transposition mechanism (91), and the laser marker (12) is fixedly disposed on a side wall of the marking cavity (11). Feeding position of the invention is fixed, thereby realizing standardization of marking position and greatly improving quality of laser marking, and the invention aims at design of cylindrical precision devices, and automatically marks cylindrical precision devices by rotating when laser marking is carried out, and solves problem that there are fewer types of laser marking devices for this type of precision devices in market.

### TECHNICAL FIELD

The present invention relates to a streetlight capable of reducing air pollution of road.

### BACKGROUND OF THE INVENTION

With the development of society, the number of private cars in the society is increasing. However, due to the use of internal combustion engine to drive vehicles, a large number of vehicle exhaust will be generated in the process of driving on the road. The vehicle exhaust contains a large number of dust particles, such as PM2.5, which will seriously cause air pollution and harm people's health. At present, street lamps are set on both sides of the road to provide lighting. However, its function is too single, and the existing way to reduce road air pollution is to spray water solution into the atmosphere. This way requires vehicles to travel along the road, affecting the normal process of vehicles. Moreover, this way is easy to cause road wet and slippery, affecting the normal walking of pedestrians, and the treatment effect is limited. Therefore, the invention aims to design a method that does not affect pedestrians and vehicles. Street lights to reduce road air pollution.

### BRIEF SUMMARY OF THE INVENTION

The purpose of the invention is to provide a streetlight capable of reducing air pollution of road to overcome the problems existing in the prior art.

A streetlight capable of reducing air pollution of road of the present invention comprises a marking box; a marking cavity disposed in the marking box, wherein the marking cavity is provided with a laser marker, a rotation mechanism, power mechanisms and a transposition mechanism, and the laser marker is fixedly disposed on a side wall of the marking cavity.

In a further technical proposal, the transposition mechanism comprises a power shaft rotatably disposed in the marking cavity; a middle block fixedly connected to an upper end of the power shaft; transposition blocks symmetrically and fixedly disposed at both side ends of the middle block; clamping mechanisms that are configured to clamp a cylindrical precision device disposed in the transposition blocks; in use, the cylindrical precision device is placed at a designated position, and the clamping mechanisms clamp the cylindrical precision device, and the power shaft is rotated, and thus the cylindrical precision device is transported to the rotation mechanism.

In a further technical proposal, the rotation mechanism comprises connection shafts symmetrically and rotatably disposed in the marking cavity, wherein the connection shafts are able to vertically slide; clamping blocks fixedly connected to ends of the connection shafts; in use, the cylindrical precision device is transported to the clamping blocks by the transposition mechanism, and the connection shafts close to each other to fix the the cylindrical precision device, and the clamping mechanisms are separated from the cylindrical precision device at this time, and the laser marker is operated, and the connection shafts are rotated to drive the cylindrical precision device to rotate through the clamping blocks, so that laser marking is performed.

In a further technical proposal, the power mechanisms comprises an upper power mechanism fixedly disposed at a top wall of the marking cavity, wherein the upper power mechanism is configured to drive the connection shafts to perform vertical displacement; a lower power mechanism disposed at a bottom wall of the marking cavity, wherein the lower power mechanism is configured to drive the connection shafts to rotate; a middle power mechanism disposed in the marking cavity, wherein the middle power mechanism is configured to drive the clamping mechanisms to operate; support boards; guide grooves disposed at side end surfaces of the support boards; electric push rods fixedly disposed in side walls of the guide grooves; connection rods slidably disposed in the guide grooves, wherein the electric push rods is fixedly connected with the connection rods; in use, the electric push rods are operated to push the connection rods toward a side; an upper rack fixedly disposed on an end of one of the connection rods in the upper power mechanism; a lower rack fixedly disposed on an end of one of the connection rods in the lower power mechanism; a spring cavity that opens downward disposed in one of the connection rods in the middle power mechanism; a sliding rod slidably disposed in the spring cavity; a spring connected between the sliding rod and a top wall of the spring cavity; a middle rack fixedly disposed on a lower end of the sliding rod; in use, the upper power mechanism, the middle power mechanism and the lower power mechanism are started in proper order.

In a further technical proposal, a fixation plate is fixedly connected to a rear wall of the marking cavity through a connection block, and a lead screw groove is disposed at a front end of the fixation plate, and a lead screw is rotatably disposed in the lead screw groove, wherein an upper end of the lead screw extends into the marking cavity, and a rotation gear is fixedly disposed on the upper end of the lead screw, wherein the rotation gear is able to be meshed with the upper rack, and movement rods are symmetrically and slidably disposed in the lead screw groove, wherein the movement rods are threadedly connected with the lead screw, and connection plates are fixedly disposed on front ends of the movement rods, wherein the connection shafts rotatably disposed in the connection plates, and a pulley shaft is rotatably disposed on the top wall of the marking cavity, and a transmission gear is fixedly disposed on a lower end of the pulley shaft, in use, after the upper rack is meshed with the rotation gear, the upper rack is meshed with the transmission gear, and a cam shaft is rotatably disposed on the rear wall of the marking cavity, wherein transmission between the cam shaft and the pulley shaft is achieved by a pulley mechanism, and a cam is fixedly disposed on a front end of the cam shaft, wherein the cam is abutted against an upper end surface of the middle rack.

In a further technical proposal, the clamping mechanisms comprise threaded rods rotatably disposed on the transposition blocks; guide grooves disposed at ends of the transposition blocks; clamping plates symmetrically and slidably disposed in the guide grooves; clamping grooves disposed at ends of the clamping plates; gears that are located between the clamping plates fixedly disposed on the threaded rods.

In a further technical proposal, a spline hole that opens downward is disposed in a lower one of the connection shafts, and a spline shaft is in splined engagement within the spline hole, and the spline shaft is rotatably connected to the rear wall of the marking cavity, and an input gear that is able to be meshed with the lower rack is fixedly disposed on a lower end of the spline shaft.

In a further technical proposal, a motor is fixedly disposed on the bottom wall of the marking cavity, and a lower end of the power shaft is in power connection with the motor, and a feeding tube located at an upper of one of the clamping grooves is disposed in the marking cavity, and a feeding cavity that opens toward a side is disposed in the marking box, and the feeding cavity is communicated with the marking cavity.

Benefits of the present invention are as follows: the invention realizes actions of automatic feeding, clamping and marking, which greatly improves efficiency of laser marking and saves labor cost; compared with manual feeding, feeding position of the invention is fixed, thereby realizing standardization of marking position and greatly improving quality of laser marking; the invention aims at design of cylindrical precision devices, and automatically marks cylindrical precision devices by rotating when laser marking is carried out, and solves problem that there are fewer types of laser marking devices for this type of precision devices in market.

### BRIEF DESCRIPTION OF THE DRAWINGS

For better explaining the technical proposal in the present invention embodiments or the prior art, the drawings to be used in the description of the embodiments or the prior art will be briefly described below. Obviously, the drawings in the following description are only some embodiments of the present invention. For those common technicians in this field, other drawings may also be obtained based on these drawings without any creative work.

FIG. 1 is an overall structural diagram of the present invention;

FIG. 2 is a structural diagram along “A-A” direction in FIG. 1;

FIG. 3 is a structural diagram along “B-B” direction in FIG. 1;

FIG. 4 is a structural diagram along “C-C” direction in FIG. 1;

### DETAILED DESCRIPTION OF THE INVENTION

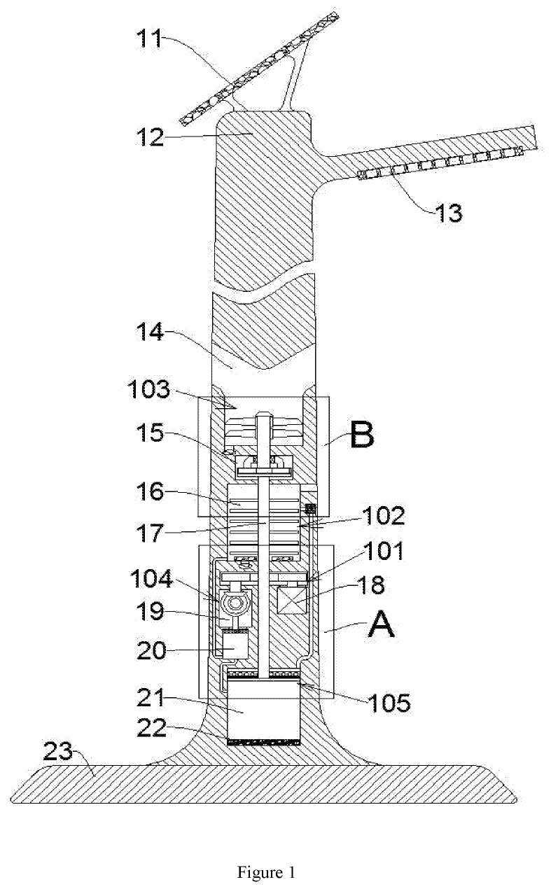

The preferred embodiments of the present invention will be described in detail in the following in combination with the drawings above. For better explanation, the orientations described hereinafter are defined as follows: directions of left, right, front and rear in the text are identical to the directions of up and down of FIG. 1.

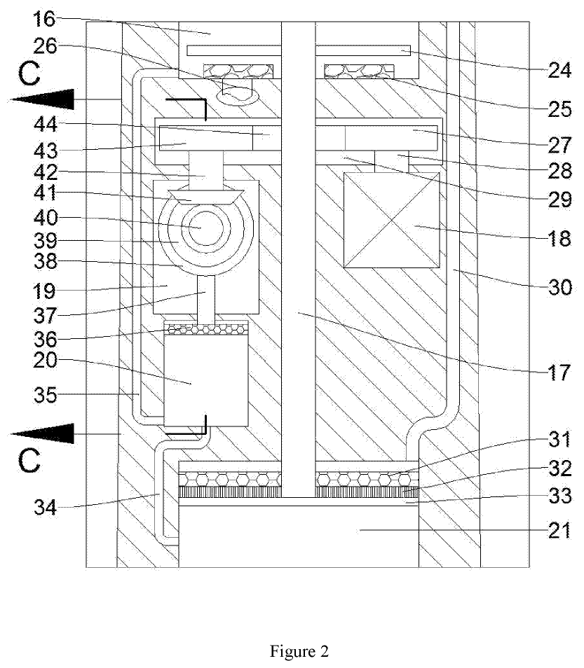

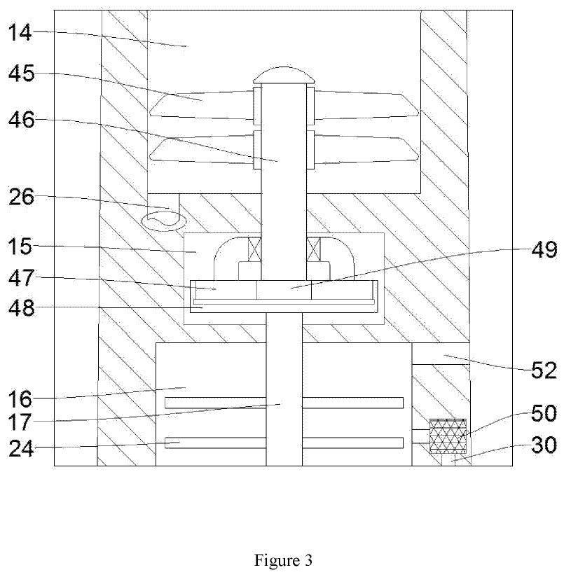

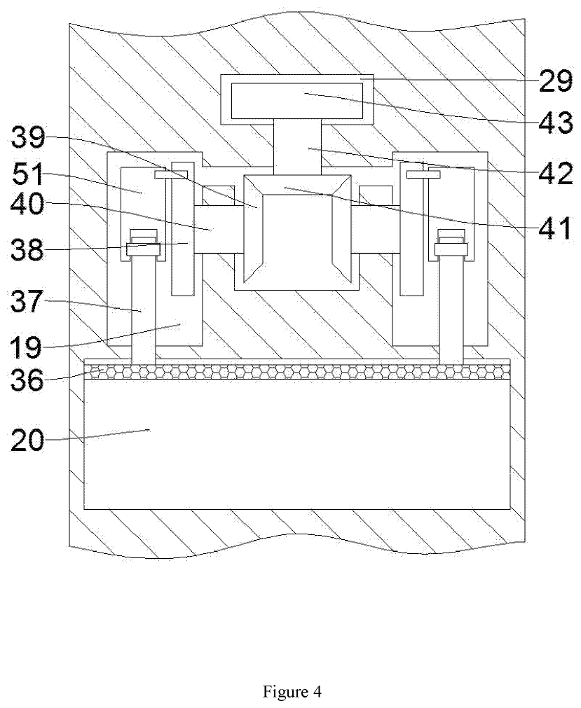

Referring to FIGS. 1-6, a laser marking equipment for precision devices of the present invention comprises a marking box 10; a marking cavity 11 disposed in the marking box 10, wherein the marking cavity 11 is provided with a laser marker 12, a rotation mechanism 90, power mechanisms 92 and a transposition mechanism 91, and the laser marker 12 is fixedly disposed on a side wall of the marking cavity 11.

The transposition mechanism 91 comprises a power shaft 36 rotatably disposed in the marking cavity 11; a middle block 34 fixedly connected to an upper end of the power shaft 36; transposition blocks 49 symmetrically and fixedly disposed at both side ends of the middle block 34; clamping mechanisms 93 that are configured to clamp a cylindrical precision device 16 disposed in the transposition blocks 49; in use, the cylindrical precision device 16 is placed at a designated position, and the clamping mechanisms 93 clamp the cylindrical precision device 16, and the power shaft 36 is rotated, and thus the cylindrical precision device 16 is transported to the rotation mechanism 90.

The rotation mechanism 90 comprises connection shafts 31 symmetrically and rotatably disposed in the marking cavity 11, wherein the connection shafts 31 are able to vertically slide; clamping blocks 14 fixedly connected to ends of the connection shafts 31; in use, the cylindrical precision device 16 is transported to the clamping blocks 14 by the transposition mechanism 91, and the connection shafts 31 close to each other to fix the the cylindrical precision device 16, and the clamping mechanisms 93 are separated from the cylindrical precision device 16 at this time, and the laser marker 12 is operated, and the connection shafts 31 are rotated to drive the cylindrical precision device 16 to rotate through the clamping blocks 14, so that laser marking is performed.

The power mechanisms 92 comprises an upper power mechanism 60 fixedly disposed at a top wall of the marking cavity 11, wherein the upper power mechanism 60 is configured to drive the connection shafts 31 to perform vertical displacement; a lower power mechanism 62 disposed at a bottom wall of the marking cavity 11, wherein the lower power mechanism 62 is configured to drive the connection shafts 31 to rotate; a middle power mechanism 61 disposed in the marking cavity 11, wherein the middle power mechanism 61 is configured to drive the clamping mechanisms 93 to operate; support boards 21; guide grooves 26 disposed at side end surfaces of the support boards 21; electric push rods 25 fixedly disposed in side walls of the guide grooves 26; connection rods 24 slidably disposed in the guide grooves 26, wherein the electric push rods 25 is fixedly connected with the connection rods 24; in use, the electric push rods 25 are operated to push the connection rods 24 toward a side; an upper rack 54 fixedly disposed on an end of one of the connection rods 24 in the upper power mechanism 60; a lower rack 43 fixedly disposed on an end of one of the connection rods 24 in the lower power mechanism 62; a spring cavity 51 that opens downward disposed in one of the connection rods 24 in the middle power mechanism 61; a sliding rod 52 slidably disposed in the spring cavity 51; a spring 53 connected between the sliding rod 52 and a top wall of the spring cavity 51; a middle rack 40 fixedly disposed on a lower end of the sliding rod 52; in use, the upper power mechanism 60, the middle power mechanism 61 and the lower power mechanism 62 are started in proper order.

A fixation plate 13 is fixedly connected to a rear wall of the marking cavity 11 through a connection block 46, and a lead screw groove 17 is disposed at a front end of the fixation plate 13, and a lead screw 29 is rotatably disposed in the lead screw groove 17, wherein an upper end of the lead screw 29 extends into the marking cavity 11, and a rotation gear 28 is fixedly disposed on the upper end of the lead screw 29, wherein the rotation gear is able to be meshed with the upper rack 54, and movement rods 47 are symmetrically and slidably disposed in the lead screw groove 17, wherein the movement rods 47 are threadedly connected with the lead screw 29, and connection plates 32 are fixedly disposed on front ends of the movement rods 47, wherein the connection shafts 31 rotatably disposed in the connection plates 32, and a pulley shaft 20 is rotatably disposed on the top wall of the marking cavity 11, and a transmission gear 18 is fixedly disposed on a lower end of the pulley shaft 20, in use, after the upper rack 54 is meshed with the rotation gear 28, the upper rack 54 is meshed with the transmission gear 18, and a cam shaft 50 is rotatably disposed on the rear wall of the marking cavity 11, wherein transmission between the cam shaft 50 and the pulley shaft 20 is achieved by a pulley mechanism 19, and a cam 30 is fixedly disposed on a front end of the cam shaft 50, wherein the cam 30 is abutted against an upper end surface of the middle rack 40.

The clamping mechanisms 93 comprise threaded rods 37 rotatably disposed on the transposition blocks 49; guide grooves 48 disposed at ends of the transposition blocks 49; clamping plates 15 symmetrically and slidably disposed in the guide grooves 48; clamping grooves 41 disposed at ends of the clamping plates 15; gears 38 that are located between the clamping plates 15 fixedly disposed on the threaded rods 37.

A spline hole 33 that opens downward is disposed in a lower one of the connection shafts 31, and a spline shaft 44 is in splined engagement within the spline hole 33, and the spline shaft 44 is rotatably connected to the rear wall of the marking cavity 11, and an input gear 45 that is able to be meshed with the lower rack 43 is fixedly disposed on a lower end of the spline shaft 44.

A motor 35 is fixedly disposed on the bottom wall of the marking cavity 11, and a lower end of the power shaft 36 is in power connection with the motor 35, and a feeding tube 39 located at an upper of one of the clamping grooves 41 is disposed in the marking cavity 11, and a feeding cavity 42 that opens toward a side is disposed in the marking box 10, and the feeding cavity 42 is communicated with the marking cavity 11.

Sequence of mechanical action of the whole device is as follows:

The upper power mechanism 60 is started, and the upper rack 54 moves toward a side and is meshed with the rotation gear 28, and the rotation gear 28 drives the lead screw 29 to rotate, and the connection plates 32 are driven to close to each other, and the cylindrical precision device 16 is clamped by the connection plates 32 through the clamping blocks 14, and the upper rack 54 is separated from the rotation gear 28 and is meshed with the transmission gear 18, and the cam 30 is driven to rotate through the pulley mechanism 19, and thus the middle rack 40 is pressurized downward, and thus the middle rack 40 is meshed with the gears 38;

The upper power mechanism 60 is stopped, and the middle power mechanism 61 is started to drive the middle rack 40 to move toward a side, and the gears 38 drive the threaded rods 37 to rotate, and the clamping plates 15 are driven to close to each other, and the cylindrical precision device 16 falls into the feeding cavity 42, and the feeding tube 39 is operated, so that a next one of the cylindrical precision device 16 is placed between the clamping grooves 41;

The middle power mechanism 61 is stopped, and the lower power mechanism 62 is started, and the lower rack 43 moves toward a side and is meshed with the input gear 45, and the cylindrical precision device 16 is driven to rotate through the spline shaft 44, the connection shafts 31 and the clamping blocks 14, and the laser marker 12 is operated to perform marking, and the lower mechanism 62 resets after marking;

The middle power mechanism 61 is started and reset, and the cylindrical precision device 16 is clamped by the clamping plates 15, and the cylindrical precision device 16 in the feeding cavity 42 is manually taken out, and the upper power mechanism 60 is started and reset, and the cam 30 is reset, and the clamping blocks 14 are separated from the cylindrical precision device 16;

The motor 35 is started to drive the middle block 34 to rotate half a circle, and process of a next one of the cylindrical precision device 16 is performed.

Persons skilled in the art should understand that, the invention is not subject to restrictions of the embodiments above, the embodiments and descriptions stated above only describe the principle of the present invention. The invention will be subject to modification and improvement based on its intention and extent, which will also fall into the claimed protection extent of this invention. The claimed protection extent of the invention shall be determined with reference to the appended claims and any equivalents thereof.

1. A streetlight capable of reducing air pollution of road, comprising:
a marking box;
a marking cavity disposed in the marking box, wherein the marking cavity is provided with a laser marker, a rotation mechanism, power mechanisms and a transposition mechanism, and the laser marker is fixedly disposed on a side wall of the marking cavity.

2. The streetlight capable of reducing air pollution of road as defined in claim 1, wherein the transposition mechanism comprises a power shaft rotatably disposed in the marking cavity;
a middle block fixedly connected to an upper end of the power shaft; transposition blocks symmetrically and fixedly disposed at both side ends of the middle block;
clamping mechanisms that are configured to clamp a cylindrical precision device disposed in the transposition blocks;
in use, the cylindrical precision device is placed at a designated position, and the clamping mechanisms clamp the cylindrical precision device, and the power shaft is rotated, and thus the cylindrical precision device is transported to the rotation mechanism.

3. The streetlight capable of reducing air pollution of road as defined in claim 1, wherein the rotation mechanism comprises connection shafts symmetrically and rotatably disposed in the marking cavity, wherein the connection shafts are able to vertically slide;
clamping blocks fixedly connected to ends of the connection shafts;
in use, the cylindrical precision device is transported to the clamping blocks by the transposition mechanism, and the connection shafts close to each other to fix the the cylindrical precision device, and the clamping mechanisms are separated from the cylindrical precision device at this time, and the laser marker is operated, and the connection shafts are rotated to drive the cylindrical precision device to rotate through the clamping blocks, so that laser marking is performed.

4. The streetlight capable of reducing air pollution of road as defined in claim 1, wherein the power mechanisms comprises an upper power mechanism fixedly disposed at a top wall of the marking cavity, wherein the upper power mechanism is configured to drive the connection shafts to perform vertical displacement;
a lower power mechanism disposed at a bottom wall of the marking cavity, wherein the lower power mechanism is configured to drive the connection shafts to rotate;
a middle power mechanism disposed in the marking cavity, wherein the middle power mechanism is configured to drive the clamping mechanisms to operate;
support boards;
guide grooves disposed at side end surfaces of the support boards;
electric push rods fixedly disposed in side walls of the guide grooves;
connection rods slidably disposed in the guide grooves, wherein the electric push rods is fixedly connected with the connection rods;
in use, the electric push rods are operated to push the connection rods toward a side;
an upper rack fixedly disposed on an end of one of the connection rods in the upper power mechanism;
a lower rack fixedly disposed on an end of one of the connection rods in the lower power mechanism;
a spring cavity that opens downward disposed in one of the connection rods in the middle power mechanism;
a sliding rod slidably disposed in the spring cavity;
a spring connected between the sliding rod and a top wall of the spring cavity;
a middle rack fixedly disposed on a lower end of the sliding rod;
in use, the upper power mechanism, the middle power mechanism and the lower power mechanism are started in proper order.

5. The streetlight capable of reducing air pollution of road as defined in claim 4, wherein a fixation plate is fixedly connected to a rear wall of the marking cavity through a connection block,
and a lead screw groove is disposed at a front end of the fixation plate,
and a lead screw is rotatably disposed in the lead screw groove, wherein an upper end of the lead screw extends into the marking cavity,
and a rotation gear is fixedly disposed on the upper end of the lead screw, wherein the rotation gear is able to be meshed with the upper rack,
and movement rods are symmetrically and slidably disposed in the lead screw groove,
wherein the movement rods are threadedly connected with the lead screw,
and connection plates are fixedly disposed on front ends of the movement rods, wherein the connection shafts rotatably disposed in the connection plates,
and a pulley shaft is rotatably disposed on the top wall of the marking cavity,
and a transmission gear is fixedly disposed on a lower end of the pulley shaft,
in use, after the upper rack is meshed with the rotation gear, the upper rack is meshed with the transmission gear,
and a cam shaft is rotatably disposed on the rear wall of the marking cavity, wherein transmission between the cam shaft and the pulley shaft is achieved by a pulley mechanism,
and a cam is fixedly disposed on a front end of the cam shaft, wherein the cam is abutted against an upper end surface of the middle rack.

6. The streetlight capable of reducing air pollution of road as defined in claim 2, wherein the clamping mechanisms comprise threaded rods rotatably disposed on the transposition blocks;
guide grooves disposed at ends of the transposition blocks;
clamping plates symmetrically and slidably disposed in the guide grooves;
clamping grooves disposed at ends of the clamping plates;
gears that are located between the clamping plates fixedly disposed on the threaded rods.

7. The streetlight capable of reducing air pollution of road as defined in claim 5, wherein a spline hole that opens downward is disposed in a lower one of the connection shafts,
and a spline shaft is in splined engagement within the spline hole,
and the spline shaft is rotatably connected to the rear wall of the marking cavity,
and an input gear that is able to be meshed with the lower rack is fixedly disposed on a lower end of the spline shaft.
